(19) United States
(12) Patent Application Publication
(10) Pub. No.: US 2021/0072935 A1
(43) Pub. Date: Mar. 11, 2021

(54) ANALYSIS INFORMATION COLLECTION PROGRAM AND ANALYSIS INFORMATION COLLECTION SYSTEM

(71) Applicant: Shimadzu Corporation, Kyoto (JP)

(72) Inventors: Kazuhito WAKABAYASHI, Kyoto (JP); Yugo HASE, Kyoto (JP)

(21) Appl. No.: 16/959,919

(22) PCT Filed: Mar. 29, 2018
(86) PCT No.: PCT/JP2018/013415

§ 371 Date: Jul. 2, 2020

(51) Int. Cl. G06F 3/12; H04L 29/08

(52) U.S. Cl. CPC G06F 3/1225; G06F 3/1276; H04L 67/1097; H04L 67/06; G06F 3/128

(57) ABSTRACT

A printer driver to be installed on a PC connected to an analysis device has a function of generating a PDF file of an analysis result report generated based on analysis data (postscript printer driver unit 252), a function of extracting text information such as sample information from the PDF file (text information extraction processing unit 253), a function of extracting a file path of an analysis raw data file from the text information and acquiring the analysis raw data file (analysis raw data acquisition processing unit 254), and a function of transmitting a PDF file of an analysis result report, an analysis raw data file, and the like to a database server PC through a LAN and registering them in a database (database registration processing unit 255). With this, the PDF file and/or the analysis raw data file can be registered in the database without outputting it to a network shared folder, which can achieve high security.

### TECHNICAL FIELD

The present invention relates to an analysis information collection system for collecting information including various data acquired by various analysis devices (e.g., a chromatograph, a spectrophotometer, a mass spectrometer, and the like) used for an instrument analysis. It also relates to a computer program for collecting analysis information used in the system.

### BACKGROUND OF THE INVENTION

In recent years, control of an analysis device and processing of analysis data acquired as a result of an analysis are generally performed using analysis control software running on a general computer. Further, in companies and laboratories having a number of analysis devices to perform analyses on a daily basis, it is configured in many cases such that data collected in each of a number of analysis devices is centrally managed by a database of a server computer. As a system for collecting and managing information acquired by such an analysis device (hereinafter simply referred to as “system”), for example, a system using a computer program (software) described in Non-Patent Document 1 is known.

FIG. 3 is a schematic configuration diagram of the above-described conventional system. In FIG. 3, an acquisition controller PC 2 connected to an analysis device 1 such as a liquid chromatograph (LC), a client PC 4, and a database server PC 5 are all connected to a network line 3 such as a local area network (LAN). The acquisition controller PC 2 is installed with dedicated software for controlling the operation of the connected analysis device 1 and for processing data acquired by the analysis device 1. The database server PC 5 is equipped with a mass storage device and is installed with software for utilizing the storage device as a database. The client PC 4 is installed with dedicated software for collecting data, etc., collected by the analysis device 1 from the acquisition controller PC 2 through the network line 3, formatting the collected data into a format registerable with the database, and then transmitting it to the database server PC 5 through the network line 3 to register in the database.

The “LabSolutions CS” disclosed in Non-Patent Document 1 is software for this. The client PC data processing unit 400 embodied by executing the software in the client PC 4 includes, as functional blocks, a PDF file generation monitoring unit 401, a PDF file acquisition unit 402, a text information etc extraction unit 403, an analysis raw data file storage position information acquisition unit 404, an analysis raw data file acquisition unit 405, a database registration processing unit 406, and the like.

The specific procedure for registering various types of data acquired by the analysis in this system in the database will be described.

The analysis device 1 performs an analysis on a sample under the control of the acquisition controller PC 2 to acquire chromatogram data. In a data processing unit realized by software installed on the acquisition controller PC 2, an analysis raw data file containing the collected raw data (chromatogram data) is generated, and the file is stored in a shared folder predesignated by the acquisition controller PC 2. Further, the data processing unit performs predetermined data processing on the collected chromatogram data and performs a quantitative analysis data calculation. This data processing unit has an analysis result report generation function as described in Patent Document 1, and collects sample information, quantitative calculation results, etc., and prepares an analysis result report according to a preset format. FIG. 4 is an example of an analysis result report to be generated. When the report destination printer is set to a printer driver for a PDF output at this time, the generated analysis result report will be output not to a paper but to a shared folder predesignated by the acquisition controller PC 2 as a PDF file.

In the client PC data processing unit 400, the PDF file generation monitoring unit 401 periodically or non-periodically checks whether or not a PDF file exists in the designated shared folder on the network. When the PDF file generation monitoring unit 401 detects that a PDF file is output to a predetermined shared folder, the PDF file acquisition unit 402 acquires the PDF file of the analysis result report from the predetermined shared folder of the acquisition controller PC 2 through the network line 3. The text information etc extraction unit 403 analyzes the acquired PDF file, refers to the mapping information acquired from the database server PC 5, and extracts text information including character information such as a sample name and numeric information such as a quantitative value. Mapping information denotes information indicating what information is described at which position in the analysis result report output in the PDF format, and differs depending on the format of the analysis result report to be used.

When the file path indicating the storage position of the analysis raw data file is included in the extracted text information, the analysis raw data file storage position information acquisition unit 404 acquires the file path, and the analysis raw data file acquisition unit 405 accesses the shared folder indicated by the file path through the network line 3 to read the analysis raw data file. The database registration processing unit 406 transmits the PDF file of the acquired analysis result report or the analysis raw data file, and the text information extracted from the PDF file, etc., to the database server PC 5 through the network line 3, and registers them in the database constructed on the server PC 5.

As described above, immediately after the output of the PDF file of the analysis result report to the shared folder in the acquisition controller PC 2, the PDF file, the analysis raw data file, etc., are registered in the database on the database server PC 5.

In some cases (for example, depending on the processing software installed on the acquisition controller PC 2), the information of the file path indicating the storage position of the analysis raw data file is not included in the analysis result report. In such a case, the user separately sets the information indicating the storage position of the analysis raw data file to the client PC 4, and the analysis raw data file acquisition unit 405 accesses the shared folder indicated by the set information to acquire the analysis raw data file.

The feature of the analysis information collection in the above-described system is that the main functions for the data collection are aggregated into the client PC 4 and the acquisition controller PC 2 only needs to output the analysis result report in a PDF file format and the analysis raw data file in an arbitrary file format (e.g., text format, CDF format, Excel format, spreadsheet format, etc.) to a shared folder on the network. As long as the acquisition controller PC 2 is equipped with the software having such a function, information including the analysis data and/or the analysis result can be collected and registered in a database regardless of the type of the analysis device 1 or regardless of the manufacturer of the analysis device 1.

However, the conventional system has the following problems.

(1) In the above-described system, the client PC 4 is required to read the analysis raw data file from the folder which is an output destination of the analysis raw data file in the acquisition controller PC 2. Therefore, the folder which is the output destination of the analysis raw data file must be set as a shared folder that can be accessed from the network line 3 side. However, such a setting may result in a security hole, which increases the likelihood of malicious access or attacks from a completely different PC or the like connected to the network line 3.

(2) In an operation on an OS in a common Windows (registered mark) provided by Microsoft (registered mark) corporation, an operation of setting an output destination to a shared folder must be performed for each analysis raw data file to be generated each time an analysis is performed, and therefore the operation is troublesome and time consuming.

(3) In the above-described system, the PDF file of the analysis result report which is the material of the information collection in the acquisition controller PC 2 is also once output to the common folder. This PDF file destination folder may also become a security hole, and therefore the PDF file is likely to be tampered with or deleted as soon as it is output to the folder.

(4) It is always required for the client PC 4 to reside a service program (program corresponding to PDF file generation monitoring unit 401) for constantly monitoring a certain folder on the network line 3, which increases the load of the client PC 4.

(5) It is required to provide a client PC 4 separately from the acquisition controller PC 2, which increases the cost of the system. Therefore, there is a demand to simplify the system by omitting the client PC 4 while suppressing the increase of the load on the acquisition controller PC 2 as much as possible.

### PRIOR ART DOCUMENT

### Patent Document

Patent Document 1: WO 2017/098793
Patent Document 2: Japanese Unexamined Patent Application Publication No. 2010-55512 (paragraph [0006])

### Non-Patent Document

Non-Patent Document 1: “LabSolutions CS Freely accessing analytical networks,” Shimadzu Corporation, [online], [Search on Mar. 28, 2018], Internet <URL: http://www.an.shimadzu.co.jp/data-net/labsolutions/cs/index.htm>

### SUMMARY OF THE INVENTION

### Problems to be Solved by the Invention

The present invention has been made in order to solve the above-described problems, and a main object thereof is to provide an analysis information collection system and an analysis information collection program capable of realizing high-security while suppressing a system cost.

### Means for Solving the Problem

A program for collecting analysis information according to the present invention made to solve the above-described problems is a printer driver type program to be installed on a computer terminal in an analysis information collection system in which the computer terminal configured to process analysis data collected by an analysis device and a database server configured to accumulate various types of analysis information are connected via a communication line, the program makes the computer terminal operate as:

a) a PDF file generation function unit configured to generate a PDF file of an analysis result report in response to an output instruction of the analysis result report generated based on the analysis data;

b) a text information extraction function unit configured to extract text information from the generated PDF file;

c) an analysis raw data file acquisition function unit configured such that when storage position information in which an analysis raw data file is stored is included in the extracted text information, a storage position is specified based on the storage position information and when the storage position information is not included in the text information, the storage position is specified based on pre-specified information and then the analysis raw data file is acquired from the storage position in the storage unit; and

d) a database registration processing function unit configured to transmit the acquired analysis raw data file, the PDF file, and at least a part of the text information to the database server through the communication line to register on a database.

An analysis information collection system according to the present invention made to solve the above-described problems is an analysis information collection system in which a processing terminal configured to process analysis data collected by an analysis device and a database server configured to accumulate various analysis information are connected via a communication line, the processing terminal comprises:

a) a storage unit configured to store an analysis raw data file in which analysis raw data collected by the analysis device is made into a file;

b) an analysis result report generation processing unit configured to generate an analysis result report in a predetermined format based on the analysis raw data or an analysis result acquired by performing predetermined processing on the analysis raw data;

c) a PDF file generation unit configured to generate a PDF file of the analysis result report in response to an output instruction of the generated analysis result report;

d) a text information extraction unit configured to extract text information from the generated PDF file;

e) an analysis raw data file acquisition unit configured such that when storage position information in the storage unit in which the analysis raw data file is stored is included in the extracted text information, a storage position is specified based on the storage position information and when the storage position information is not included in the text information, the storage position is specified based on pre-specified information and then the analysis raw data file is acquired from the storage position in the storage unit; and

f) a database registration processing unit configured to transmit the acquired analysis raw data file, the PDF file, and at least a part of the text information to the database server through the communication line to register on a database.

Note that the “printer driver type program” refers to a program in which, at the time of performing a print instruction in an application program that generated an original document, when a printer driver for generating a PDF such as “Adobe PDF” of Adobe (Adobe is a registered mark) corporation is selected as the output destination of the printer, predetermined processing is performed on the document in response to the print command and output it, like a program that generates and outputs a PDF file from a print command (see Patent Document 2, etc.).

In other words, the analysis information collection system according to the present invention can be configured such that a part of its function is realized by an analysis information collection program according to the present invention, that is, a printer driver type program.

In the present invention, the number of computer terminals or processing terminals may be one or more. An analysis device is connected to the computer terminal or the processing terminal, but only one analysis device may be connected to one terminal or a plurality of analysis devices may be connected to one terminal. The type of this analysis device is not limited, but may typically be a chromatographic device, such as, e.g., an LC and a GC, a mass spectrometer, a spectrophotometer, or the like. The computer terminal or the processing terminal has a function of processing the data collected by the analysis device but may have a function of controlling the operation of the analysis device.

In the analysis information collection system according to the present invention, the analysis information is registered in the database on the database server directly via the communication line from the processing terminal which is directly connected to the analysis device (i.e., not via the network line but via a dedicated cable line or the like) and processes the data collected by analysis device. However, the software for performing data processing or control of the analysis device in a personal computer or a tablet computer that is a processing terminal directly connected to the analysis device is dedicated software corresponding to the analysis device. Therefore, for example, in cases where analysis devices of various manufacturers are mixed, it is difficult to incorporate the above-described program for an analysis information collection into the dedicated software corresponding to the analysis device. On the other hand, in the present invention, the printer driver which is printer controlling software used to print an analysis result report generated on a computer has a function for an analysis information collection.

In the analysis information collection system according to the present invention, when analysis raw data is generated by performing an analysis in the analysis device, in the processing terminal connected to the analysis device, an analysis raw data file in which the analysis raw data collected by the analysis device is made into a file is generated and stored in the storage unit. Further, the analysis result report generation processing unit generates an analysis result report in a predetermined format based on the analysis raw data or the analysis result such as a quantitative result acquired by performing predetermined processing on the analysis raw data. At this time, depending on the format, it is possible to include the storage position on the storage unit in which the analysis raw data file is stored in the analysis result report.

In cases where the output (database registration) of the generated analysis result report is instructed, the generated analysis result report is passed to the printer driver for the printout, but in the printer driver, the PDF file generation unit first generates a PDF file for the analysis result report. Subsequently, the text information extraction unit extracts text information, such as, e.g., characters and numeric values, from the generated PDF file. It should be noted that what information exists at which position of the analysis result report differs depending on the format of the report. Therefore, when extracting the text information, it is better to use mapping information provided in advance in which the position on the report and the type of information are associated.

When the storage position information of the analysis raw data file is included in the extracted text information, the analysis raw data file acquisition unit acquires the analysis raw data file using the information. On the other hand, when the storage position information of the analysis raw data file is not included in the analysis result report, the position information is not included in the text information. In this case, for example, the analysis raw data file is acquired based on the information of the storage destination of the analysis raw data file designated in advance (or determined by default) by the user. The database registration processing unit transmits the acquired analysis raw data file, the PDF file of the analysis result report, and at least a part of the extracted text information to the database server through the communication line and registers them in the database constructed on the server.

As described above, in the analysis information collection system according to the present invention, it is possible to automatically register the PDF file of the analysis result report or the analysis raw data file acquired by the analysis, etc., in the database on the database server directly from the processing terminal via the communication line immediately after the generation of the PDF file of the analysis result report by the function of the printer driver mounted on the processing terminal.

### Effects of the Invention

According to the present invention, it is not necessary to output the PDF file of the analysis result report generated by the computer terminal connected to the analysis device or the analysis raw data file to the shared folder on the network. Therefore, it is difficult to access such files from another PC, etc., connected to the network line. Thereby, it is possible to configure a highly reliable analysis information collection system in which security holes are unlikely to occur and malicious tampering or deletion of data is prevented.

Further, the above-described database registration function can be realized by the printer driver installed on the computer terminal. The printer driver is software different from data processing software for processing data collected from the analysis device. Therefore, the above-described function can be added even in cases where the data processing software itself cannot be modified. Further, it is not necessary to separately prepare a PC for database registration processing required in the above-described conventional system, so that the cost of the system can be reduced.

### BRIEF DESCRIPTION OF THE DRAWINGS

FIG. 1 is a schematic entire configuration diagram of an analysis information collection system which is an example of the present invention.

FIG. 2 is a diagram showing a functional block of a data processing unit embodied in an acquisition controller PC in the analysis information collection system of this example.

FIG. 3 is a schematic configuration diagram of a conventional analysis information collection system.

FIG. 4 is a diagram showing an example of an analysis result report.

### EMBODIMENTS FOR CARRYING OUT THE INVENTION

Hereinafter, an analysis information collection system which is an example of the present invention will be described in detail with reference to the attached drawings.

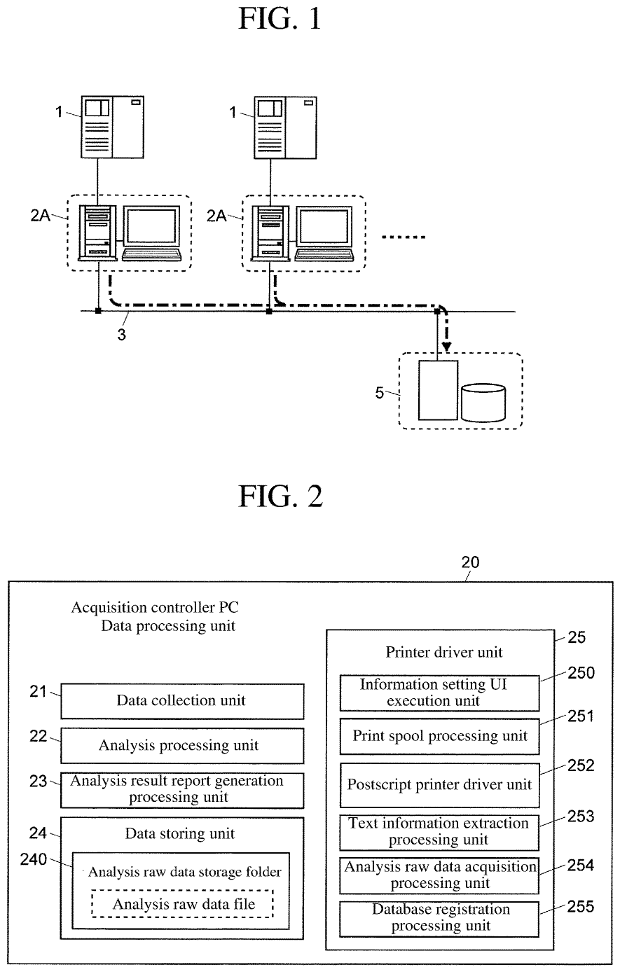

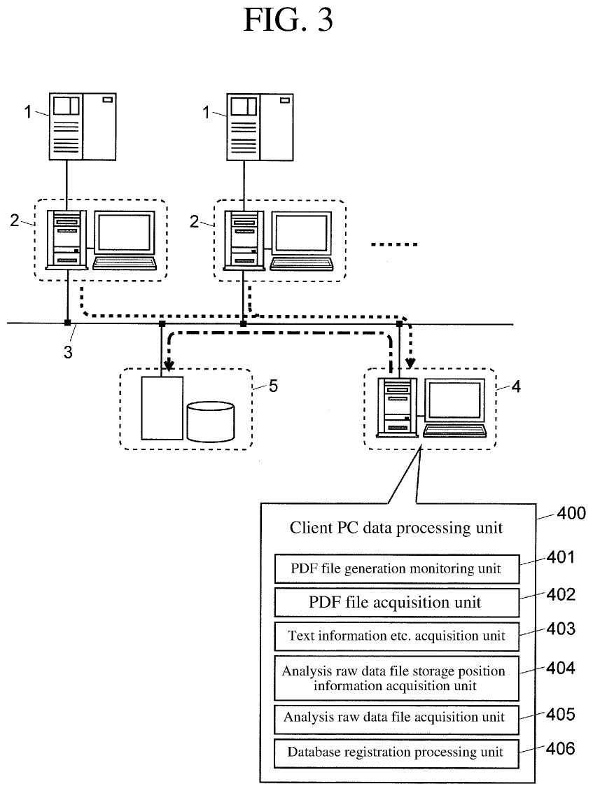

FIG. 1 is a schematic entire configuration diagram of an analysis information collection system of this example. In this system, an acquisition controller PC 2A connected to an analysis device 1 such as an LC and a database server PC 5 are connected to a network line 3 such as a LAN, and there is no PC corresponding to the client PC 4 in FIG. 3. A standard OS such as Windows is installed on the acquisition controller PC 2A, and dedicated software for controlling the operation of the analysis device 1 and processing the data acquired by the analysis device 1 running on the OS are installed as one of application programs. This is the same as the acquisition controller PC 2 in the conventional system shown in FIG. 3.

In the system of this embodiment, a characteristic printer driver is installed on acquisition controller PC 2A of this example. The main function of a general printer driver is to output documents, figures and tables, etc., based on the data stored in a designated file to a designated printer to print or output to a designated folder. However, the printer driver has a characteristic function in this system. Note that for convenience of explanation, it is assumed that the OS (operating system) used in the acquisition controller PC 2A is Windows.

FIG. 2 is a diagram showing main functional blocks of a data processing unit 20 embodied by executing the data processing software and the printer driver installed on the acquisition controller PC 2A on the PC. This data processing unit 20 is provided with functional blocks, such as, e.g., a data collection unit 21, an analysis processing unit 22, an analysis result report generation processing unit 23, a data storage unit 24, and a printer driver unit 25. The printer driver unit 25 is provided with functional blocks, such as, e.g., an information setting UI (user interface) executing unit 250, a print spool processing unit 251, a postscript printer driver unit 252, a text information extraction processing unit 253, an analysis raw data acquisition processing unit 254, and a database registration processing unit 255.

Next, the process flow at the time of registering the analysis information in the database in the system of this example will be described. Note that in the information setting UI execution unit 250, information related to the communication, such as, e.g., the IP address of the database server PC 5 which is the registration destination of the analysis information, is registered in advance.

In the data processing unit 20, the data collection unit 21 acquires the data sequentially acquired by performing an analysis on a sample in the analysis device 1. When the analysis device 1 is an LC, this data is chromatogram data acquired over time. The data collection unit 21 generates an analysis raw data file including the collected data and prints it to the analysis raw data storage folder 240 in the data storage unit 24. This analysis raw data storage folder 240 can be specified by a user in advance, or when it is not specified by a user, it may be set by default. Note that it may be configured such that data such as an analytical condition data is included in the analysis raw data file.

The analysis processing unit 22 performs, for example, a quantitative analysis by performing predetermined waveform processing, arithmetic processing, and the like on the collected data as described above. Specifically, a predetermined wave treatment is performed on a chromatogram generated based on the collected chromatogram data to detect the peak, and the retention time and the area value (or a height value) of the peak are acquired for each detected peak. Then, after identifying or confirming the compound corresponding to the peak based on retention time information, a quantitative value (concentration value) is calculated from the peak area value (or height value) in light of the calibration curve prepared in advance. Thus, it is possible to acquire the quantitative value for each compound included in the sample.

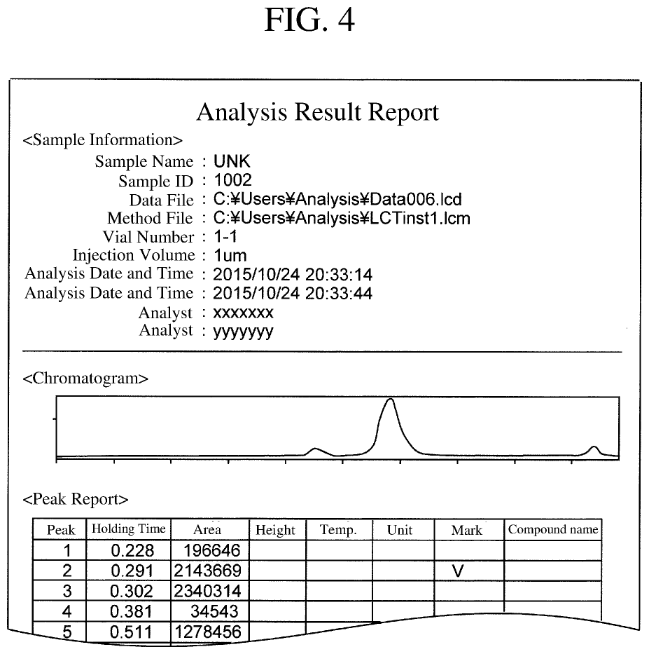

The analysis result report generation processing unit 23 generates an analysis result report in a predetermined format based on an instruction from a user. As disclosed in Patent Document 1, etc., the analysis result report may include sample information such as a sample name, a graph which is an analysis result such as a chromatogram, a peak area value which is an analysis result, a quantitative value, and the like. Generally speaking, the analysis result report as shown, for example, in FIG. 4 can be completed by preparing a number of templates in the report form, selecting any one of the templates by a user, and arranging sample information, figures, etc., to fill in each item of the selected template.

After the analysis result report is generated as described above, a user instructs to execute the database registration on the generated analysis result report. This instruction can be performed by, for example, selecting the database as the print destination as the print instruction.

Upon receipt of the above-described instruction in the printer driver unit 25, the print spool processing unit 251 calls the GDI (Graphics Device Interface) API (Application Programming Interface), which is a standard in Windows, in order to draw the data constituting the specified analysis result report to the device context of the printer, and the GDI draws data to the device context of the printer. Thereafter, the print spool processing unit 251 generates the raw data for printing based on a printer language. And the postscript printer driver unit 252 generates a PDF file based on the generated raw data. The processing up to this point is the functions which are also equipped by the printer driver installed in the acquisition controller PC 2 in the conventional systems shown in FIG. 3.

Upon generation of the PDF file, the text information extraction processing unit 253 analyzes the PDF file and refers to the mapping information indicating the correspondence relationship between the position on the report and the type of information to extract the text information, such as, e.g., the sample information and the quantitative value. The mapping information may be acquired from the database server PC 5 as required, or may be registered in advance in the information setting UI execution unit 250. Then, the analysis raw data acquisition processing unit 254 extracts the file path of the analysis raw data file from the extracted text information by referring to the mapping information and acquires the analysis raw data file from the analysis raw data storage folder 240 of the storage unit 24 indicated by the file path. In the example of FIG. 4, “C:¥Users¥Analysis¥Data006.1cd” is the file path of the analysis raw data file.

The database registration processing unit 255 transmits, in addition to the acquired analysis raw data file, the PDF file of the analysis result report and the text information extracted from the file to the database server 5 through the network line 3 and registers the information in the database constructed on the server 5. In this case, the information related to the communication registered in the information setting UI execution unit 250 is utilized.

In the system of this example as described above, when an output instruction to the database of the analysis result report is made, various information related to the analysis is automatically registered in the database on the database server 5 according to the instruction. This database registration processing is executed individually, or for each acquisition controller PC 2A basis, by the printer driver installed on the acquisition controller PC 2A directly connected to the analysis device 1. Therefore, when this printer driver is installed on the PC connected to the analysis device 1, the analysis raw data file, etc., can be registered in the database without relying on the application program for data processing.

It should be noted that the above-described example is an example of the present invention, and it is apparent that appropriate modifications, changes, and additions are included within the range of the spirit of the present invention

### DESCRIPTION OF SYMBOLS

1: Analysis device
2A: Acquisition controller PC
20: Data processing unit
21: Data collection unit
22: Analysis processing unit
23: Analysis result report generation processing unit
24: Data storage unit
240: Analysis raw data storage folder
25: Printer driver unit
250: Information setting UI execution unit
251: Print spool processing unit
252: Postscript printer driver unit
253: Text information extraction processing unit
254: Analysis raw data acquisition processing unit
255: Database registration processing unit
3: Network line
5: Database server PC

1. A computer-readable non-transitory recording medium storing a printer driver type program to be installed on a computer terminal in an analysis information collection system in which the computer terminal configured to process analysis data collected by an analysis device and a database server configured to accumulate various types of analysis information are connected via a communication line, the program makes the computer terminal operate as:
a) a PDF file generation function unit configured to generate a PDF file of an analysis result report in response to an output instruction of the analysis result report generated based on the analysis data;
b) a text information extraction function unit configured to extract text information from the generated PDF file;
c) an analysis raw data file acquisition function unit configured such that when storage position information of a storage unit in which an analysis raw data file is stored is included in the extracted text information, a storage position is specified based on the storage position information and when the storage position information is not included in the text information, the storage position is specified based on pre-specified information and then the analysis raw data file is acquired from the storage position in the storage unit; and
d) a database registration processing function unit configured to transmit the acquired analysis raw data file, the PDF file, and at least a part of the text information to the database server through the communication line to register on a database.

2. An analysis information collection system in which a processing terminal configured to process analysis data collected by an analysis device and a database server configured to accumulate various analysis information are connected via a communication line, the processing terminal comprises:
a) a storage unit configured to store an analysis raw data file in which analysis raw data collected by the analysis device is made into a file;
b) an analysis result report generation processing unit configured to generate an analysis result report in a predetermined format based on the analysis raw data or an analysis result acquired by performing predetermined processing on the analysis raw data;
c) a PDF file generation unit configured to generate a PDF file of the analysis result report in response to an output instruction of the generated analysis result report;
d) a text information extraction unit configured to extract text information from the generated PDF file;
e) an analysis raw data file acquisition unit configured such that when storage position information in the storage unit in which the analysis raw data file is stored is included in the extracted text information, a storage position is specified based on the storage position information and when the storage position information is not included in the text information, the storage position is specified based on pre-specified information and then the analysis raw data file is acquired from the storage position in the storage unit; and
f) a database registration processing unit configured to transmit the acquired analysis raw data file, the PDF file, and at least a part of the text information to the database server through the communication line to register on a database.
